(19) United States
(12) Patent Application Publication
(10) Pub. No.: US 2025/0154423 A1
(43) Pub. Date: May 15, 2025

(54) CARBON COMPOUND MATERIAL, CARBON STORAGE MATERIAL CONTAINING CARBON COMPOUND MATERIAL, AND METHOD FOR PRODUCING CARBON COMPOUND MATERIAL

(71) Applicant: AISIN CORPORATION, Kariya (JP)

(72) Inventors: Toru JOBOJI, Kariya-shi (JP); Maki Nagano, Kariya-shi (JP)

(73) Assignee: AISIN CORPORATION, Kariya (JP)

(21) Appl. No.: 18/937,380

(22) Filed: Nov. 5, 2024

(30) Foreign Application Priority Data
Nov. 10, 2023 (JP) 2023-192380

(51) Int. Cl. C10L 5/44

(52) U.S. Cl. CPC C10L 5/447; C10L 2200/0469; C10L 2290/28; C10L 2290/544

(57) ABSTRACT

A carbon compound material includes: a solid material containing a biomass raw material containing at least one of cellulose or lignin. The solid material has a carboxy group, a fixed carbon rate of 20% or more, and an average diameter of 1 μm or more and 1000 μm or less.

### CROSS REFERENCE TO RELATED APPLICATIONS

This application is based on and claims priority under 35 U.S.C. § 119 to Japanese Patent Application 2023-192380, filed on Nov. 10, 2023, the entire content of which is incorporated herein by reference.

### TECHNICAL FIELD

This disclosure relates to a carbon compound material, a carbon storage material containing a carbon compound material, and a method for producing a carbon compound material.

### BACKGROUND DISCUSSION

In recent years, a technique for producing a biomass fuel from non-food biomass (cellulosic biomass) such as wood, grass, and rice straw has attracted attention instead of food biomass such as sugar cane and corn.

JP 2013-111034A (Reference 1) discloses a method for producing a biomass fuel in which a biomass raw material containing cellulose is pulverized under heating at 100° C. or higher and lower than 300° C., and a saccharified solution is extracted with water.

JP 2015-35973A (Reference 2) discloses a method for producing a saccharified solution by bringing a carbide carbonized at a temperature of 150° C. to 500° C. into contact with a biomass raw material containing cellulose and hydrolyzing the biomass raw material, and a method for using a saccharified residue after extracting the saccharified solution as a catalyst for a hydrolysis reaction.

When a biomass fuel is produced from a cellulosic biomass raw material, it is necessary to decompose the cellulose to extract a portion that becomes saccharide. However, cellulose has a strong molecular structure and is not easily decomposed. A method for saccharifying cellulose using a strong acid such as sulfuric acid has been known for a long time. However, when the strong acid is neutralized, there has been a problem that a process is complicated due to a large amount of gypsum or the like generated as waste and a long time is required, and thus an energy load at the time of production is large. There are few examples in which a portion other than the saccharide is effectively put into practical use as a saccharified residue, and there is a problem that many of portions are discarded.

Reference 1 does not describe a saccharified residue after extracting a saccharified solution, and does not disclose a method for using the saccharified residue. In Reference 2, it is possible to further increase efficiency of monosaccharide recovery by using a saccharified residue as a catalyst for a hydrolysis reaction, but since polysaccharides, lignin, and the like contained in the saccharified residue cannot be decomposed by a carbide, the saccharified residue is not effectively utilized.

A need thus exists for a carbon compound material, a carbon storage material containing a carbon compound material, and a method for producing a carbon compound material which are not susceptible to the drawback mentioned above.

### SUMMARY

A characteristic feature of a carbon compound material according to this disclosure is that a compound material includes a solid material containing a biomass raw material containing at least one of cellulose or lignin, in which the solid material has a carboxy group, a fixed carbon rate of 20% or more, and an average diameter of 1 μm or more and 1000 μm or less.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a process block diagram according to a first embodiment;

FIG. 2 is a process block diagram according to a second embodiment; and

FIG. 3 is a result of thermogravimetry according to Example 1.

### DETAILED DESCRIPTION

Hereinafter, embodiments of a carbon compound material according to this disclosure will be described with reference to the drawings. In the present embodiment, as an example of the carbon compound material, a carbon compound material using a biomass containing at least one of cellulose or lignin as a raw material will be described. This disclosure is not limited to the following embodiments, and various modifications can be made without departing from the gist of this disclosure.

A solid material disclosed here contains a biomass raw material containing at least one of cellulose or lignin. The biomass raw material containing at least one of cellulose or lignin is a raw material containing at least a component of cellulose or lignin. Examples include grass or plant biomass such as rice straw, wheat straw, and bagasse, thinned wood such as bamboo and bamboo grass, a wood biomass such as wood waste from wood processing such as sawdust, chips, and offcuts, roadside tree pruning, wooden building waste, bark and driftwood, and a cellulose product such as waste paper. Sludge, livestock excrement, agricultural waste, urban waste, and the like can also be used so long as cellulose or lignin is contained to an extent that the cellulose or lignin can be used as the biomass raw material. These biomass raw materials may be used alone or in combination of a plurality of different types, and for example, may contain, in addition to cellulose or lignin, polysaccharide such as starch, hemicellulose, and pectin.

The solid material disclosed here has a fixed carbon rate of 20% or more, preferably 30% or more, and more preferably 40% or more. An upper limit of the fixed carbon rate is 100%, and a higher fixed carbon rate indicates a higher content of flame-retardant carbon. That is, since the fixed carbon rate is an index capable of stably fixing carbon in a solid state as a carbon compound material over a long period of time without releasing carbon dioxide absorbed by plants into the atmosphere, the higher the fixed carbon rate, the better.

The fixed carbon rate herein can be measured by thermogravimetric analysis using a Q-500 device (manufactured by TA Instruments). That is, a 10 mg solid sample is heated from room temperature to 107° C. at a heating rate of 30° C./min in a nitrogen atmosphere and then held at that temperature for 3 minutes (a weight loss relative to a mass of the sample at the time of weight stabilization is referred to as “moisture”), and then heated to 600° C. at a heating rate of 50° C./min, and then heated to 900° C. at a heating rate of 100° C./min, and held at that temperature for 3 minutes (a weight loss relative to the mass of the sample is determined, and a value obtained by subtracting moisture quantified at the same time is referred to as “volatile content”), then the temperature is decreased to 815° C. at a cooling rate of 30° C./min, the atmosphere is changed from the nitrogen atmosphere to an oxygen atmosphere, the sample is held for 30 minutes, the weight loss relative to the mass of the sample is determined, and a value obtained by subtracting moisture and a volatile content quantified at the same time is defined as a fixed carbon rate.

The solid material disclosed here has a carboxy functional group. It is presumed that such a functional group is generated due to a chemical reaction caused by a mechanochemical effect, which increases the fixed carbon rate and generates a carboxy group. When the solid material has a carboxy group, for example, the carboxy group is ionized in a soil and bonds with a fertilizer component such as Mg ions, resulting in good affinity with the soil. When a solid material is fixed to a substance, the carboxy group acts to enhance affinity, and a material having excellent dispersibility is obtained. Accordingly, a carbon storage material made of a solid material can be scattered in the soil or fixed to a substance.

The fact that the solid material disclosed here has a carboxy group can be confirmed by, for example, measuring an infrared absorption spectrum using a Fourier transform infrared spectrometer. Specifically, the solid material is added to KBr and adjusted, mixed uniformly using a mortar, an obtained mixture is processed into pellets, an infrared absorption spectrum is obtained using a Fourier transform infrared spectrometer FT/IR-6100 (manufactured by JASCO Corporation), and an absorption peak of 3300 cm⁻¹ to 2500 cm⁻¹ is determined to be derived from a carboxy functional group, and presence or absence thereof is evaluated. It can also be confirmed by performing a solid 13C-NMR measurement.

The solid material disclosed here has an average diameter of 1 μm or more and 1000 μm or less, preferably 5 μm or more and 500 μm or less, and more preferably 10 μm or more and 300 μm or less. With such an average diameter, it is possible to fill the soil with the solid material as it is as fine powder. When the solid material is mixed in a substance, a function and quality are improved, and thus the solid material can be fixed in the substance over a long period of time.

Average diameter measurement disclosed here can be confirmed by, for example, measurement with a particle size distribution meter using a laser diffraction scattering method. Specifically, a volume average particle diameter of the solid material is measured by a wet method (ethanol solvent) using LMS-2000e (manufactured by Seishin Enterprise Co., Ltd.), and a particle diameter corresponding to a median cumulative value is defined as an average diameter from a cumulative curve of a particle diameter distribution of the volume average particle diameter.

The solid material disclosed here is preferably insoluble in water. The term “insoluble” as used herein means a component that is not extracted as an aqueous solution when the solid material is washed with water. If the solid material is insoluble in water, decomposition of the solid material hardly proceeds, and the solid material tends to be retained for a long time even if the solid material is fixed in the ground, a substance, or the like.

The solid material disclosed here preferably exhibits a peak at 650° C. or higher and 840° C. or lower in differential thermal analysis. Such a peak is derived from recombination with hydrocarbon type fragmentation, such as flame-retardant carbon, making it easier to maintain the solid material in a stable state. Such analysis can be measured by differential thermal analysis using a differential thermal-thermogravimetric analyzer Q-600 (manufactured by TA Instruments). Specifically, a 10 mg solid sample is measured in a nitrogen atmosphere from room temperature to 1000° C. at a heating rate of 30° C./min, and a result can be confirmed by an exothermic peak detected at 650° C. or higher and 840° C. or lower.

### First Embodiment

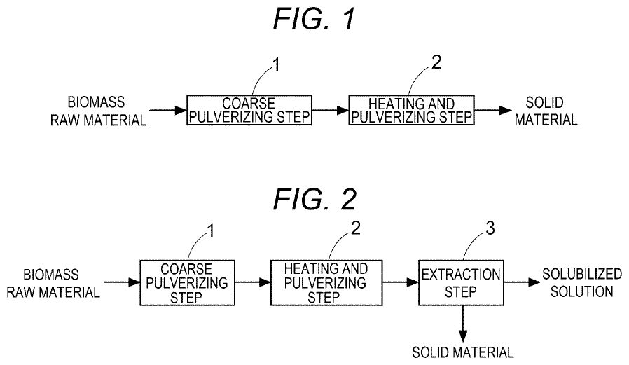

Next, a method for producing a solid material according to a first embodiment will be described with reference to FIG. 1. A biomass raw material containing at least one of cellulose or lignin is converted into a solid material through a coarse pulverizing step 1 and a heating and pulverizing step 2.

The biomass raw material used in the present embodiment is coarsely pulverized in the coarse pulverizing step 1. In the coarse pulverizing step 1, it is preferable that the material is pulverized to a size of about 1 mm to 10 mm. In the coarse pulverizing step 1, a pulverizing method can be selected according to a form of the biomass raw material. For example, a general-purpose pulverizer such as a hammer mill, a cutter mill, a vibration mill, a ball mill, a rod mill, a roller mill, a colloid mill, a disk mill, or a jet mill can be used. For a pulverization treatment in the coarse pulverizing step 1, either a dry or wet method can be selected, and dry pulverization is preferred from a viewpoint of reducing crystallinity of cellulose and lignin. When a water content of the raw material is high, the crystallinity of cellulose or lignin can be efficiently reduced by adjusting the water content to 30% by mass or less in advance by centrifugal dehydration, hot air drying, or the like, and then performing dry pulverization.

The coarsely pulverized biomass raw material used in the present embodiment is heated and pulverized in the heating and pulverizing step 2. When the biomass raw material is heated and carbonized, a proportion of fixed carbon increases to obtain a carbon compound material. As described above, the fixed carbon refers to carbon in a stable state calculated as an amount of combustible substance remaining at high temperature in an oxygen-free state. Such a carbon compound material is usually produced by so-called “steaming” of a biomass raw material. However, when much of carbon contained in the biomass raw material combines with oxygen by heating, carbon is released as carbon dioxide to the atmosphere. In the related art, in order to produce a high-quality carbon compound material having a high fixed carbon rate, it is necessary to heat a biomass raw material at a high temperature for a long time. Accordingly, when the carbon compound material is generated, a generation amount of carbon dioxide is large, resulting in a low yield. On the other hand, when the biomass raw material is heated at a low temperature for a long time in order to reduce a generation amount of carbon dioxide, there is a problem that only a low-quality carbon compound material can be obtained although the yield is high. That is, there is a trade-off relationship between the generation amount of carbon dioxide and quality of the carbon compound material, that is, the fixed carbon rate.

In the heating and pulverizing step 2, a heating and pulverizing treatment is performed using a ball mill under heating at 100° C. or higher and lower than 300° C. The biomass raw material is heated and pulverized until an average diameter becomes 1 μm or more and 1000 μm or less in order to make it possible to fill the soil with the solid material as it is or to fix the solid material to a substance. A rotation speed is preferably in a range of more than 300 rpm to 2000 rpm. The higher the rotation speed, the easier the carbonization proceeds. However, in view of a balance with production energy and a load on the device, the rotation speed is preferably more than 500 rpm and less than 2000 rpm, and more preferably more than 1000 rpm and less than 2000 rpm, from which the solid material can be most efficiently obtained. The atmosphere in the heating and pulverizing step 2 may be a normal pressure or vacuum, or may be any atmosphere selected from the group consisting of oxygen, nitrogen, argon, and a rare gas.

By performing a heating and pulverizing treatment using a ball mill under heating at 100° C. or higher and lower than 300° C., it is possible to obtain a mechanochemical effect by heating and pulverizing and to promote decomposition of the biomass raw material. That is, it is presumed that the biomass raw material is decomposed into components such as cellulose, hemicellulose, and lignin by hydrolysis, frictional heat and reaction heat generated by the ball mill activate a molecular motion of cellulose or the like, accelerating a decrease in crystallinity and a reduction in molecular weight, and further, another reaction occurs, molecules are re-polymerized, and a cyclization reaction or the like proceeds, and thus a solid material having a high fixed carbon rate is obtained.

The heating and pulverizing treatment is preferably performed for 0.5 hours or more. Since a reaction such as repolymerization proceeds as a time increases, it is desirable to perform a long-time treatment. However, in order to efficiently obtain a solid material, the treatment is preferably performed for about 0.5 hours to 5 hours. As described above, since the biomass raw material can be carbonized at a low temperature and in a short time by utilizing the mechanochemical effect, a solid material of higher quality can be obtained by a simpler method than in the related art. Since a solvent or a catalyst is not used in the heating and pulverizing step 2, it is safe in a carbonization process, and manufacturing cost can be reduced.

A heating method is not particularly limited, and a container can be heated using an electric heater, a high frequency wave, a microwave, steam, or the like. The pulverization may be performed by a ball mill such as a planetary ball mill. When the ball mill is used, the biomass raw material is subjected to a large gravitational acceleration from balls. Therefore, the mechanochemical effect due to pulverization can be extremely increased, and the biomass raw material can be carbonized in a short time. The heating and pulverizing treatment may be performed at a normal pressure or in a vacuum.

### Second Embodiment

FIG. 2 is a process block diagram of a method for producing a solid material according to a second embodiment. A biomass raw material containing at least one of cellulose or lignin is subjected to a coarse pulverizing step 1 and a heating and pulverizing step 2 to become a pulverized product, and then a water-soluble component is extracted in an extraction step 3. Other configurations are the same as those of the first embodiment, and detailed description of the same configurations as those of the first embodiment is omitted.

The pulverized product subjected to the heating and pulverizing treatment in the heating and pulverizing step 2 contains monosaccharides or polysaccharides as a raw material for the biomass fuel. Since the monosaccharides and polysaccharides are water-soluble components, the monosaccharides and polysaccharides can be extracted with water. In the related art, a biomass raw material containing cellulose is solubilized by causing a hydrolysis reaction in a subcritical region or a supercritical region of water. However, according to the present embodiment, the treatment can be performed at a low temperature in a short time by going through the heating and pulverizing step 2 and the extraction step 3. Since the biomass raw material can be solubilized and carbonized by a simple method without using a solvent or a catalyst, the production energy is small and a process is safe. Further, since the saccharified residue can be obtained as a solid material that can be used as a carbon storage material or the like, it is not necessary to perform a step of treating the saccharified residue after the biomass raw material is solubilized.

In the present embodiment, the heating and pulverizing treatment is preferably performed for about 0.5 hours to 5 hours.

In the extraction step 3, it is desirable to add water to the pulverized product obtained in the heating and pulverizing step 2 in an amount of 0.1 times to 500 times and mix the mixture, and perform solid-liquid separation using a solid-liquid separation device to obtain a solubilized solution and a solid material that is a saccharified residue. Examples of the solid-liquid separation device include devices using a gravity settling method, a centrifugal separation method, a membrane separation method, a coagulation separation method, and a flotation separation method.

The solubilized solution obtained in the extraction step 3 may be mixed with a solid acid catalyst and stirred to perform hydrolysis to obtain a saccharified solution containing monosaccharide such as glucose as a main component. The saccharified solution thus obtained can be fermented and distilled to obtain ethanol as a biomass fuel.

The water-insoluble saccharified residue in the extraction step 3 can be obtained as a solid material. The solid material is directly used as a carbon compound material to form a carbon storage material, or is molded and processed using a carbon compound material to form the carbon storage material. Since the solid material thus obtained is a by-product at the time of producing a biomass fuel, an emission amount of carbon dioxide in a life cycle assessment is reduced.

### EXAMPLES

Hereinafter, examples disclosed here will be described, but this disclosure is not limited to the description of the examples. First, a method for evaluating various characteristics used in the present example will be specifically described.

### (1) Evaluation of Fixed Carbon Rate

Using a thermogravimetric analysis Q-500 device (manufactured by TA Instruments), a 10 mg of solid material was heated from room temperature to 107° C. at a heating rate of 30° C./min in a nitrogen atmosphere and then held at that temperature for 3 minutes (a weight loss relative to a mass of the sample at the time of weight stabilization was referred to as “moisture”), and then heated to 600° C. at a heating rate of 50° C./min, and then heated to 900° C. at a heating rate of 100° C./min, and held at that temperature for 3 minutes (a weight loss relative to the mass of the sample was determined, and a value obtained by subtracting moisture quantified at the same time was referred to as “volatile content”), then the temperature was decreased to 815° C. at a cooling rate of 30° C./min, the atmosphere was changed from the nitrogen atmosphere to an oxygen atmosphere, the sample was held for 30 minutes, a weight loss relative to the mass of the sample was determined, and a value obtained by subtracting moisture and a volatile content quantified at the same time was calculated as the fixed carbon rate. A numerical value is calculated up to one decimal place, and then the first decimal place is rounded.

### (2) Solubility Evaluation

The solid material was washed using water in an amount of 10 times a mass of the solid material, and it was visually checked whether any part remained as a solid without being extracted as an aqueous solution when washed.

### (3) Differential Thermal Analysis Measurement

A 10 mg of solid material was heated from room temperature to 1000° C. at a heating rate of 30° C./min in a nitrogen atmosphere using a differential thermal-thermogravimetric analyzer Q-600 (manufactured by TA Instruments) to obtain a differential thermal analysis curve. Based on database of differential thermal analysis curves of forest felled timber described in “Hirohisa Yoshida/Nobuyoshi Koga, Thermal Analysis 4th Edition, pp. 243-245, Kodansha Scientific”, a characteristic exothermic peak associated with development of condensed aromatic ring structures was assigned to a range of 650° C. or higher and 840° C. or lower.

### (4) Evaluation of Carboxy Functional Group

The solid material was added to KBr and adjusted, and mixed uniformly using a mortar. An obtained mixture was processed into pellets, and an infrared absorption spectrum was obtained using a Fourier transform infrared spectrometer FT/IR-6100 (manufactured by JASCO Corporation). An absorption peak of 3300 cm⁻¹ to 2500 cm⁻¹ is determined to be derived from a carboxy functional group, and presence or absence thereof is evaluated.

### (5) Average Diameter Measurement

A volume average particle diameter of the solid material was measured by a wet method (ethanol solvent) using LMS-2000e (manufactured by Seishin Enterprise Co., Ltd.), which is a particle size distribution meter using the laser diffraction scattering method. A particle diameter corresponding to a median cumulative value was defined as an average diameter from a cumulative curve of a particle diameter distribution of the volume average particle diameter.

### Example 1

A cellulose reagent “Avicel” (registered trademark) PH-101 (manufactured by Merck) was heated and pulverized at 200° C. for 1.5 hours at 800 rpm to 1600 rpm using a ball mill with a heater (balls: 5 mmφ). After heating and pulverizing, an obtained solid material was naturally cooled, and then various evaluations were performed.

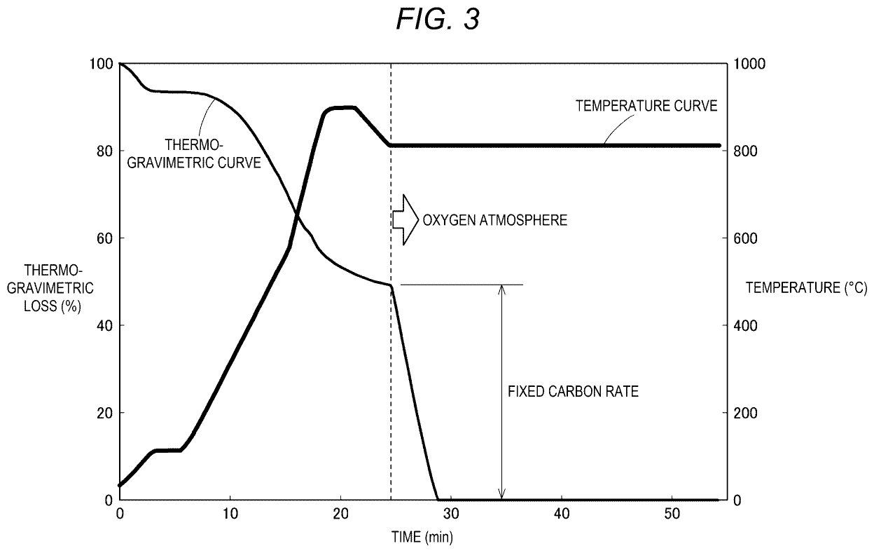

As shown in FIG. 3, the obtained solid material had a fixed carbon rate of 50%, an exothermic peak was detected at 650° C. or higher and 840° C. or lower in differential thermal analysis, an absorption peak of 3300 cm⁻¹ to 2500 cm⁻¹ was detected by a Fourier transform infrared spectrometer, and an average diameter was 20 μm.

### Example 2

A solid material was produced in a manner similar to that in Example 1, except that conditions for the heating and pulverizing treatment were changed to 170° C. for 3 hours.

An obtained solid material had a fixed carbon rate of 29%, an exothermic peak was detected at 650° C. or higher and 840° C. or lower in differential thermal analysis, an absorption peak of 3300 cm⁻¹ to 2500 cm⁻¹ was detected by a Fourier transform infrared spectrometer, and an average diameter was 24 μm.

### Comparative Example 1

A solid material was produced in a manner similar to that in Example 1, except that conditions for the heating and pulverizing treatment were changed to 200° C. for 6 hours at 300 rpm.

The obtained solid material had a fixed carbon rate of 6%. An absorption peak of 3300 cm⁻¹ to 2500 cm⁻¹ was detected by a Fourier transform infrared spectrometer, but no exothermic peak was observed at 650° C. or higher and 840° C. or lower in differential thermal analysis. An average diameter was 35 μm.

### Comparative Example 2

A cellulose reagent “Avicel” (registered trademark) PH-101 (manufactured by Merck) was heated in an electric furnace heated to 200° C. for 1.5 hours. After the heating, an obtained solid material was naturally cooled in a manner similar to that in Example 1, and then various evaluations were performed.

The obtained solid material had a fixed carbon rate of 3%. In the differential thermal analysis, no exothermic peak was observed at 650° C. or higher and 840° C. or lower. An average diameter was 43 μm.

Both solid materials of Examples 1 and 2 could achieve a fixed carbon rate of 20% or more. On the other hand, production conditions in Comparative Example 1 correspond to those of Example 1 described in Reference 1, and the fixed carbon rate did not reach 20% although a heating and pulverizing time was longer than that of Example 1. In Comparative Example 2 in which heating was performed in an electric furnace, the fixed carbon rate was significantly reduced to 3% even when a heating time was the same as in Example 1.

In the embodiments described above, the following configurations are conceivable.

(1) A carbon compound material includes: a solid material containing a biomass raw material containing at least one of cellulose or lignin, in which the solid material has a carboxy group, a fixed carbon rate of 20% or more, and an average diameter of 1 μm or more and 1000 μm or less.

The biomass raw material containing at least one of cellulose or lignin is not easily decomposed as described above, and a saccharified residue after extracting saccharide is not effectively utilized. These biomass raw materials and saccharified residues are often used as solid fuels. When these biomass raw materials and saccharified residues are burned, carbon dioxide absorbed by a plant is released into the atmosphere. However, when the carbon compound material having the above configuration has a fixed carbon rate of 20% or more, carbon can be stably stored for a long period of time. Therefore, the carbon dioxide absorbed by the plant can be retained in the carbon compound material without being released to the atmosphere, making it possible to achieve a state in which an absorption amount is larger than an emission amount of the carbon dioxide (carbon negative). Since the average diameter is 1 μm or more and 1000 μm or less, it is possible to fill a soil with the solid material as fine powder or to mix the solid material with a substance. Further, since the solid material has the carboxy group, it is possible to provide a material having high environmental affinity and low environmental load. Accordingly, it is possible to effectively use the cellulosic biomass and a saccharified residue thereof to achieve carbon negative.

(2) In the carbon compound material according to (1), the solid material is preferably insoluble in water.

In the biomass raw material, a component that is soluble in water (a portion that becomes saccharide) is used as a biomass fuel, but a component that is insoluble in water is often discarded as a saccharified residue. According to this configuration, since the saccharified residue can be effectively used as a carbon storage material, it is possible to reduce the amount of by-products during production of the biomass fuel to be discarded.

(3) In the carbon compound material according to (1) or (2), it is preferable that the solid material exhibits a peak at 650° C. or higher and 840° C. or lower in differential thermal analysis.

The peak at 650° C. or higher and 840° C. or lower in the differential thermal analysis is presumed to be formed by decomposing cellulose or lignin, which is a main component of the biomass raw material, resulting in re-polymerization of hydrocarbon species with a low molecular weight. Since such a component has a high carbon content, a carbon compound material exhibiting an exothermic peak in differential thermal analysis in this temperature range is useful as a carbon storage material.

(4) A carbon storage material includes: the carbon compound material according to any one of (1) to (3).

According to this configuration, carbon can be stably stored for a long period of time, and a carbon storage material having high environmental affinity can be provided.

(5) A method for producing a carbon compound material includes: a coarse pulverizing step 1 of coarsely pulverizing a biomass raw material containing at least one of cellulose or lignin; and a heating and pulverizing step 2 of heating and pulverizing the coarsely pulverized biomass raw material, in which the heating and pulverizing step 2 is performed using a ball mill under heating at 100° C. or higher and lower than 300° C.

When the biomass raw material is pyrolyzed, a proportion of the fixed carbon is further increased to obtain a carbon compound material. Such a carbon compound material is produced by so-called “steaming” of a biomass raw material. However, when carbon contained in the biomass raw material combines with oxygen by heating, carbon is released as carbon dioxide to the atmosphere. In the related art, in order to produce a high-quality carbon compound material, it is necessary to heat a biomass raw material at a high temperature for a long time. Accordingly, when the carbon compound material is generated, a generation amount of carbon dioxide is large, resulting in a low yield. When the biomass raw material is heated at a low temperature for a long time in order to reduce a generation amount of carbon dioxide, there is a problem that only a low-quality carbon compound material can be obtained although the yield is high. That is, there is a trade-off relationship between the generation amount of carbon dioxide and quality of the carbon compound material, that is, the fixed carbon rate.

However, by performing the method for producing a carbon compound material including the coarse pulverizing step 1 and the heating and pulverizing step 2 as in the present configuration, it is possible to reduce a generation amount of carbon dioxide and to obtain a high-quality carbon compound material with a high yield. In the coarse pulverizing step 1, the biomass raw material can be formed into a shape that can be easily handled. In the heating and pulverizing step 2, a molecular motion of cellulose or lignin is activated by heating, and cellulose or lignin can be non-crystallized by pulverization, and the molecular weight can be reduced. Therefore, it is possible to carbonize the biomass raw material at a low temperature and in a short time due to a mechanochemical effect. In particular, in the present configuration, by performing the heating and pulverizing step 2 using a ball mill in a low-oxygen atmosphere under heating at a relatively low temperature of 100° C. or higher and lower than 300° C., it is possible to reduce generation of carbon dioxide due to oxidation, and it is possible to obtain a high-quality carbon compound material at a high yield. Since a solvent or a catalyst is not used, a production process is simple, an energy load during production is small, and environmental affinity of the produced carbon compound material is high. Further, the carbon compound material can be obtained from a biomass raw material other than wood according to the present configuration, which is useful as a negative emission technique.

(6) In the method for producing a carbon compound material according to (5), the heating and pulverizing step 2 is preferably performed by rotation at more than 300 rpm and less than 2000 rpm.

According to this configuration, since the carbonization is more likely to proceed as a rotation speed in the heating and pulverizing step 2 is higher, the solid material can be efficiently obtained.

(7) The method for producing a carbon compound material according to (5) or (6) preferably further includes: an extraction step 3 of extracting, with water, a water-soluble component of a pulverized product obtained by the heating and pulverizing step 2.

By including the extraction step 3 of extracting the water-soluble component of the carbon compound material with water, the water-soluble component can be used as a biomass fuel. By using a residue after the extraction as a carbon compound material, emission of carbon dioxide in a life cycle assessment can be reduced, and therefore, the biomass raw material can be effectively used.

### Other Embodiments

(1) In the embodiment, the heating and pulverizing was performed at 100° C. to 300° C. for 0.5 hours to 5 hours. However, a solubilization rate of the biomass raw material may be measured in advance, and the heating and pulverizing treatment may be performed for a reaction time and at a reaction temperature at which the solubilization rate is maximized.

(2) A carbon compound material may be produced by mixing a fertilizer component or the like with the solid material obtained by the embodiment and granulating the mixture. Accordingly, the carbon compound material not only functions as a carbon storage material but also can be effectively used as a soil conditioner or a fertilizer.

### INDUSTRIAL APPLICABILITY

This disclosure can be used for a carbon compound material capable of effectively utilizing a saccharified residue, a carbon storage material containing a carbon compound material, and a method for producing a carbon compound material.

A characteristic feature of a carbon compound material according to this disclosure is that a compound material includes a solid material containing a biomass raw material containing at least one of cellulose or lignin, in which the solid material has a carboxy group, a fixed carbon rate of 20% or more, and an average diameter of 1 μm or more and 1000 μm or less.

The biomass raw material containing at least one of cellulose or lignin is not easily decomposed as described above, and a saccharified residue after extracting saccharide is not effectively utilized. These biomass raw materials and saccharified residues are often used as solid fuels. When these biomass raw materials and saccharified residues are burned, carbon dioxide absorbed by a plant is released into the atmosphere. However, when the carbon compound material having the above configuration has a fixed carbon rate of 20% or more, carbon can be stably stored for a long period of time. Therefore, the carbon dioxide absorbed by the plant can be retained in the carbon compound material without being released to the atmosphere, making it possible to achieve a state in which an absorption amount is larger than an emission amount of the carbon dioxide (carbon negative). Since the average diameter is 1 μm or more and 1000 μm or less, it is possible to fill a soil with the solid material as fine powder or to mix the solid material with a substance. Further, since the solid material has the carboxy group, a material having high environmental affinity can be provided. Accordingly, it is possible to effectively use a saccharified residue produced when a biomass fuel is produced and a biomass raw material other than wood to achieve the carbon negative.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A carbon compound material comprising:
a solid material containing a biomass raw material containing at least one of cellulose or lignin, wherein
the solid material has a carboxy group, a fixed carbon rate of 20% or more, and an average diameter of 1 μm or more and 1000 μm or less.

2. The carbon compound material according to claim 1, wherein
the solid material is insoluble in water.

3. The carbon compound material according to claim 1, wherein
the solid material exhibits a peak at 650° C. or higher and 840° C. or lower in differential thermal analysis.

4. A carbon storage material comprising:
the carbon compound material according to claim 1.

5. A method for producing a carbon compound material, comprising:
a coarse pulverizing step of coarsely pulverizing a biomass raw material containing at least one of cellulose or lignin; and
a heating and pulverizing step of heating and pulverizing the coarsely pulverized biomass raw material, wherein
the heating and pulverizing step is performed using a ball mill under heating at 100° C. or higher and lower than 300° C.

6. The method for producing a carbon compound material according to claim 5, wherein
the heating and pulverizing step is performed by rotation at more than 300 rpm and less than 2000 rpm.

7. The method for producing a carbon compound material according to claim 5, further comprising:
an extraction step of extracting, with water, a water-soluble component of a pulverized product obtained by the heating and pulverizing step.

8. The method for producing a carbon compound material according to claim 6, further comprising:
an extraction step of extracting, with water, a water-soluble component of a pulverized product obtained by the heating and pulverizing step.
